(19) United States
(12) Patent Application Publication
(10) Pub. No.: US 2020/0371827 A1
(43) Pub. Date: Nov. 26, 2020

(54) Method, Apparatus, Device and Medium for Processing Data

(71) Applicant: Beijing Baidu Netcom Science and Technology Co., Ltd., Beijing (CN)

(72) Inventors: Yongji Xie, Beijing (CN); Wen Chai, Beijing (CN); Yu Zhang, Beijing (CN)

(21) Appl. No.: 16/707,347

(22) Filed: Dec. 9, 2019

(30) Foreign Application Priority Data
May 24, 2019 (CN) 201910438970.2

(51) Int. Cl. G06F 9/455; G06F 9/50; G06F 3/06

(52) U.S. Cl. CPC G06F 9/45558; G06F 9/5077; G06F 9/5011; G06F 3/0631; G06F 2009/45591; G06F 3/0673; G06F 3/064; G06F 3/0614; G06F 2009/45583; G06F 3/0665

(57) ABSTRACT

Embodiments of the present disclosure provide a method, apparatus, device, and computer readable storage medium for processing data, and relate to the field of cloud computing. The method for processing data includes receiving a request for storing a data block from a virtual storage of a virtual machine into a virtual disk of the virtual machine, the request indicating a virtual storage address for storing the data block in the virtual storage and a virtual disk address for storing the data block in the virtual disk. The method further includes determining a physical storage address for storing the data block within a physical storage associated with the virtual machine based on the virtual storage address. The method further includes associatively storing the virtual disk address and the physical storage address.

### CROSS-REFERENCE TO RELATED APPLICATION

This application claims priority to Chinese Patent Application No. 201910438970.2, filed May 24, 2019, the disclosure of which is hereby incorporated by reference in its entirety.

### TECHNICAL FIELD

Embodiments of the present disclosure mainly relate to the field of computers, and more particularly to a method, apparatus, device, and computer readable storage medium for processing data.

### BACKGROUND

With the development of the computer, applications of virtual machines are increasing. For example, more and more Internet services are deployed on a cloud. After deploying the services on the cloud, users run these deployed services through a virtual machine running on the cloud. By using the virtual machine, the user service processing efficiency can be greatly improved.

In addition, when running various services through the virtual machine, various data may be processed on the virtual machine. In the process of running the services, the virtual machine can save the data processed by the virtual machine. Since the services are run through the virtual machine, different operating systems may be run on a given platform or a given host, thus improving the compatibility between the host device and different operating systems. However, in the process of using the virtual machine, various problems remain to be solved.

### SUMMARY

According to example embodiments of the present disclosure, a scheme for processing data is provided.

In a first aspect of the present disclosure, a method for processing data is provided. The method includes receiving a request for storing a data block from a virtual storage of a virtual machine into a virtual disk of the virtual machine, the request indicating a virtual storage address for storing the data block in the virtual storage and a virtual disk address for storing the data block in the virtual disk; determining a physical storage address for storing the data block within a physical storage associated with the virtual machine based on the virtual storage address; and associatively storing the virtual disk address and the physical storage address.

In a second aspect of the present disclosure, a method for processing data is provided. The method includes receiving a request for storing a data block from a virtual disk of a virtual machine into a virtual storage of the virtual machine, the request indicating a virtual storage address for storing the data block in a virtual machine storage and a virtual disk address for storing the data block in the virtual disk; determining a physical storage address for storing the data block within a physical storage associated with the virtual machine based on the virtual disk address; and associatively storing the virtual storage address and the physical storage address.

In a third aspect of the present disclosure, an apparatus for processing data is provided. The apparatus includes a first receiving module configured to receive a request for storing a data block from a virtual storage of a virtual machine into a virtual disk of the virtual machine, the request indicating a virtual storage address for storing the data block in the virtual storage and a virtual disk address for storing the data block in the virtual disk; a first physical storage address determining module configured to determine a physical storage address for storing the data block within a physical storage associated with the virtual machine based on the virtual storage address; and a first address storing module configured to associatively store the virtual disk address and the physical storage address.

In a fourth aspect of the present disclosure, an apparatus for processing data is provided. The apparatus includes a second receiving module configured to receive a request for storing a data block from a virtual disk of a virtual machine into a virtual storage of the virtual machine, the request indicating a virtual storage address for storing the data block in a virtual machine storage and a virtual disk address for storing the data block in the virtual disk; a second physical storage address determining module configured to determine a physical storage address for storing the data block within a physical storage associated with the virtual machine based on the virtual disk address; and a second address storing module configured to associatively store the virtual storage address and the physical storage address.

In a fifth aspect of the present disclosure, an electronic device is provided, including one or more processors; and a storage apparatus for storing one or more programs, when executed by the one or more processors, cause the one or more processors to implement the method according to the first aspect of the disclosure.

In a sixth aspect of the present disclosure, an electronic device is provided, including one or more processors; and a storage apparatus for storing one or more programs, when executed by the one or more processors, cause the one or more processors to implement the method according to the second aspect of the disclosure.

In a seventh aspect of the present disclosure, a computer readable storage medium is provided, storing a computer program thereon, where the program, when executed by a processor, implements the method according to the first aspect of the disclosure.

In an eighth aspect of the present disclosure, a computer readable storage medium is provided, storing a computer program thereon, where the program, when executed by a processor, implements the method according to the second aspect of the disclosure.

It should be understood that the content described in the summary section of the disclosure is not intended to limit the key or important features of the embodiments of the present disclosure, nor is it intended to limit the scope of the present disclosure. Other features of the present disclosure will become easily understood by the following description.

### BRIEF DESCRIPTION OF THE DRAWINGS

In conjunction with the accompanying drawings and with reference to detailed descriptions below, the above and other features, advantages, and aspects of various embodiments of the present disclosure will become more apparent. Identical or similar reference numerals in the accompanying drawings represent identical or similar elements.

FIG. 1 shows a schematic diagram of an example environment 100 for processing data according to embodiments of the present disclosure;

FIG. 2 shows a flowchart of a method 200 for processing data according to an embodiment of the present disclosure;

FIG. 3 shows a flowchart of a method 300 for processing data according to an embodiment of the present disclosure;

FIG. 4 shows a schematic diagram of an example environment 400 for processing data according to an embodiment of the present disclosure;

FIG. 5 shows a schematic block diagram of an apparatus 500 for processing data according to an embodiment of the present disclosure;

FIG. 6 shows a schematic block diagram of an apparatus 600 for processing data according to an embodiment of the present disclosure; and

FIG. 7 shows a block diagram of a computing device 700 that can be configured to implement a plurality of embodiments of the present disclosure.

### DETAILED DESCRIPTION OF EMBODIMENTS

Embodiments of the present disclosure will be described below in more detail with reference to the accompanying drawings. While some embodiments of the present disclosure are shown in the accompanying drawings, it should be understood that the present disclosure may be implemented in various forms, and should not be construed as being limited to the embodiments set forth herein. On the contrary, these embodiments are provided to more thoroughly and completely understand the present disclosure. It should be understood that the accompanying drawings and embodiments of the present disclosure merely play an exemplary role, and are not intended to limit the scope of protection of the present disclosure.

In the description of the embodiments of the present disclosure, the term “including” and similar wordings thereof should be construed as open-ended inclusions, i.e., “including but not limited to.” The term “based on” should be construed as “at least partially based on.” The term “an embodiment” or “the embodiment” should be construed as “at least one embodiment.” The terms, such as “first,” and “second,” may refer to different or identical objects. Other explicit and implicit definitions may be further included below.

Generally, in a computing device, when there is insufficient memory, a processor performs a transfer-out operation to store a part of infrequently used data in the memory into a disk, thus alleviating the memory pressure. When this data is required, the processor performs a transfer-in operation to read the data back from the disk. With the popularity of cloud computing, the virtual machine system also often uses such transfer-in/transfer-out mechanism. The transfer-out operation executed by a virtual machine is storing data in a virtual storage into a virtual disk. Since the virtual disk is actually simulated based on a disk file on a physical machine, i.e., the virtual disk corresponds to a preset storage space on a physical disk of the physical machine. Thus, the transfer-out operation is actually writing data of the virtual storage into the physical disk. Correspondingly, the transfer-in operation is reading required data back from the virtual disk to the virtual storage, and is actually reading corresponding data from the physical disk, and writing the corresponding data back into the virtual storage.

When a transfer-in or transfer-out operation is executed in the virtual machine, accessing to the physical disk affects the data processing efficiency. An access operation of the physical disk includes two approaches: buffered I/O and direct I/O. The buffered I/O is directly accessing to a cached page within a memory. The cached page is synchronized with the disk file at an appropriate timing. The direct I/O is a direct access operation on a disk. However, in the direct I/O, I/O operation on the disk is slow, and therefore the efficiency is low. For the buffered I/O, because the buffered I/O directly copies data in a physical storage corresponding to the virtual storage into the cached page, and is data replication within the memory, the buffered I/O is superior to the direct I/O in data transfer-out. However, for the transfer-in operation, if the cached page is destroyed, then the buffered I/O needs to first read data from the physical disk into the cached page, and then copy the data in the cached page to the physical storage corresponding to the virtual machine storage. In this case, the performance of the buffered I/O is inferior to the performance of the direct I/O. In addition, in the transfer-in operation or transfer-out operation, either approach needs to perform a data replication operation within the memory, thereby consuming a lot of time, and reducing the data processing efficiency.

According to some embodiments of the present disclosure, an improved scheme for processing data is presented. The scheme includes acquiring a request for storing a data block from a virtual storage into a virtual disk, determining a corresponding physical storage address based on a virtual storage address indicated by the request, and then achieving the data block being stored into the virtual disk based on the associated physical storage address and a virtual disk address for storing data in the virtual disk indicated by the request. When the data is stored from the virtual disk into the virtual storage, similar operations are employed, too. The scheme achieves moving the data block by modifying a mapping relationship between storage addresses of the data block, thereby reducing data replication in the process of storing the data block into the virtual disk or the virtual storage, and improving the data processing efficiency.

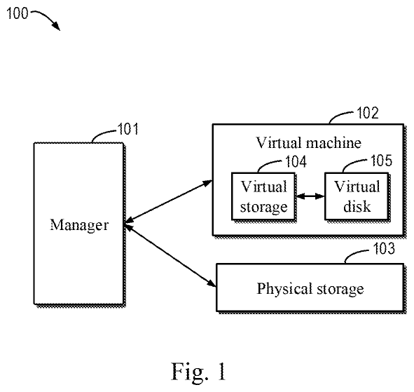

FIG. 1 shows a schematic diagram of an example environment 100 for processing data according to embodiments of the present disclosure. The example environment 100 includes a computing device, e.g., a manager 101 configured to manage running of a virtual machine 102. The manager 101 may manage the virtual machine 102, such that a data block is stored from a virtual storage 104 of the virtual machine 102 into a virtual disk 105 of the virtual machine 102, or the data block is stored from the virtual disk 105 into the virtual storage 104. The manager 101 may be a standalone computing device, or a controller in a storage system associated with the virtual machine 102, or any other suitable device capable of managing running of the virtual machine 102. The above examples are merely used for describing some embodiments of the present disclosure, rather than specifically limiting the present disclosure.

It should be understood that the virtual machine 102 in FIG. 1 is merely an example, rather than specifically limiting the present disclosure. Those skilled in the art may cause the manager 101 to manage any appropriate number of virtual machines as required.

The virtual machine 102 refers to an application execution environment created by a specific application program on a hardware platform of a physical machine. A user may run an application through the environment and interact with the application, just like using the physical machine. When creating a virtual machine, the manager 101 usually needs to allocate a certain number of resources from a host system hosting the virtual machine, for use by the virtual machine 102 during operation. The resource may be any available resource for running the virtual machine, for example, a computing resource (e.g., a CPU, a GPU, or a FPGA), a storage resource (e.g., a memory, or a storage disk), and a network resource (e.g., a network card).

The virtual machine 102 includes the virtual storage 104 and the virtual disk 105. The data block stored in the virtual storage 104 is stored into a physical storage 103 corresponding to the virtual storage 104. In some embodiments, there is mapping relationships between storage addresses of a data block on the virtual machine storage 104 and storage addresses of the data block on the physical storage 103. Alternatively or additionally, these mapping relationships are stored in a mapping table as data items. For example, the mapping table may be a shadow page table or an extended page table. Based on the storage addresses of the data block in the virtual storage 104, the manager 102 may find out a storage address of the data block in the corresponding physical storage based on the mapping table. The above examples are merely used for describing some embodiments of the present disclosure, rather than specifically limiting the present disclosure.

The data block stored in the virtual disk 105 is stored into a physical storage 103 corresponding to the virtual disk 105 or a physical disk of a host. If a data block on the virtual disk 105 is in the physical storage 103, then there is a mapping relationship between an address of the data block on the virtual disk 105 and an address of the data block on the physical storage 103. In some embodiments, the mapping relationship is stored in a host page table as a data item. If the data block on the virtual disk 105 is not in the physical storage, then the data block on the virtual disk 105 is stored on the physical disk. Additionally, there is a mapping relationship between the address of the data block on the virtual disk 105 and the address of the data block on the physical disk. The mapping relationship is implemented by a predetermined file, e.g., a host file for implementing a mapping relationship between the virtual disk and the physical disk. The above examples are merely used for describing some embodiments of the present disclosure, rather than specifically limiting the present disclosure.

The physical storage 103 is used for storing data on the virtual storage 104 and a part of data in the virtual disk 105. In some embodiments, the data block stored in the virtual disk 105 of the physical storage 103 is periodically flushed to the physical disk. In some embodiments, when a size of the data stored in the virtual disk 105 of the physical storage 103 is greater than a preset size, a data block related to the virtual disk 105 in the physical storage 103 is flushed to the physical disk. The above examples are merely used for describing some embodiments of the present disclosure, rather than specifically limiting the present disclosure.

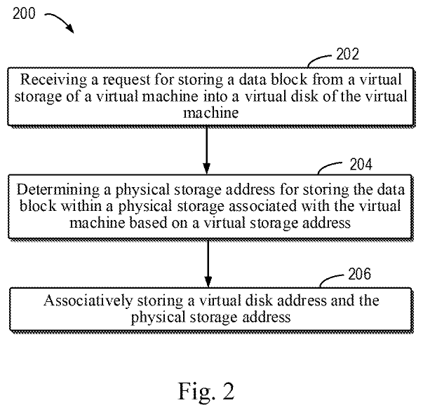

The above FIG. 1 describes the schematic diagram of the example environment 100 for processing data according to embodiments of the present disclosure. A flowchart of a method 200 for processing data according to an embodiment of the present disclosure will be described below in conjunction with FIG. 2. The method 200 may be implemented by the manager 101 in FIG. 1. For the ease of discussion, the method 200 will be described with reference to FIG. 1. It should be understood that while shown in a particular sequence, some steps of the method 200 may be performed in a sequence different from the shown sequence or be performed in parallel. Some embodiments of the present disclosure are not limited in this respect. In addition, the method 200 described in conjunction with FIG. 1 is merely an example, rather than specifically limiting the method 200.

In block 202, the manager 101 receives a request for storing a data block from the virtual storage 104 of the virtual machine 102 into the virtual disk 105 of the virtual machine 102, the request indicating a virtual storage address for storing the data block in the virtual storage 104 and a virtual disk address for storing the data block in the virtual disk 105. When executing a transfer-out operation on data in the virtual storage 104, the virtual machine 102 stores the data in the virtual storage 104 into the virtual disk 105. Thus, the virtual machine 102 sends a data transfer-out request to the manager 101. The request includes the storage address of the data block to be transferred out in the virtual storage 104 and the storage address to be used for storing the data block in the virtual disk 105.

In block 204, the manager 101 determines a physical storage address for storing the data block within the physical storage 103 associated with the virtual machine 102 based on the virtual storage address. After receiving the data transfer-out request sent by the virtual machine 102, the manager 101 determines an actual address of the data block in the physical storage based on the virtual storage address in the request. In some embodiments, there is a mapping relation between the storage address of the data block in the virtual storage 104 and the storage address of the data block in the physical storage 103. In some embodiments, the mapping relationship is stored in a first mapping table as a data item. The first mapping table, e.g., may be a shadow page table or an extended page table. Thus, the manager 101 may find out the physical storage address of the data block in the virtual storage 104 based on the first mapping table.

In block 206, the manager 101 associatively stores the virtual disk address and the physical storage address. In some embodiments, the manager 101 associatively stores the obtained physical storage address of the data block and the virtual disk address for storing the data block. For example, a mapping relationship between the physical storage address and the virtual disk address is stored in a second mapping table as a data item. The second mapping table is used for storing a mapping relationship between the address of the data block in the virtual disk 105 and the address of the data block in the physical storage 103. For example, the second mapping table may be a host page table. There is a mapping relationship between the address of the physical storage and the address of the virtual disk 105 of the data block, thus indicating that the data block is stored on the virtual disk 105.

In the process of storing data in the virtual storage into the virtual disk, only by modifying a mapping relationship between the physical storage and the virtual disk of the data block, a data transfer-out operation is achieved, thus reducing the workload of copying the data block, and improving the transfer-out efficiency.

In addition, after transferring out the data block in the virtual storage 104 to the virtual disk 105, a virtual storage block storing the data block in the virtual storage 104 needs to be mapped into a new physical storage block in the physical storage 103, such that the virtual storage block may store new data. In this case, the manager 101 allocates a new physical storage block in the physical storage 103 for the virtual machine storage 104. Then, the manager 101 associatively stores an address of the allocated new physical storage block and the virtual storage address, for example, storing in a mapping table between the virtual storage 104 and the physical storage 103.

When associatively storing the virtual disk address and the physical storage address, the manager 101 further needs to determine whether a first physical storage block in the physical storage 103 corresponds to a virtual disk storage block for storing the data block based on the virtual disk address. The first physical storage block is released, if the first physical storage block corresponding to the virtual disk storage block for storing the data block is included in the physical storage.

After completing performing the above operations, the manager 101 sends a response to the virtual machine 102 to indicate the data block being stored into the virtual disk 105.

When it is determined that the first physical storage block corresponding to the virtual disk storage block for storing the data block is included in the physical storage, the first physical storage block is released, such that a storage space of the physical storage may be used for storing other data in time, thus improving the use efficiency of the physical storage.

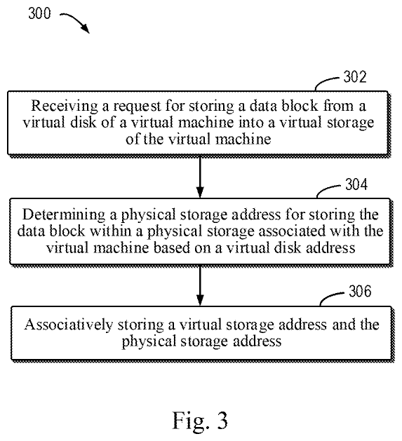

The flowchart of the method 200 for processing data according to an embodiment of the present disclosure is described above in conjunction with FIG. 2. A flowchart of a method 300 for processing data according to an embodiment of the present disclosure will be described below in conjunction with FIG. 3. The method 300 is used for storing a data block from a virtual disk into a virtual storage, and may be implemented by the manager 101 in FIG. 1. For the ease of discussion, the method 300 will be described with reference to FIG. 1. It should be understood that while shown in a particular sequence, some steps of the method 300 may be performed in a sequence different from the shown sequence or be performed in parallel. Some embodiments of the present disclosure are not limited in this respect. In addition, the method 300 described in conjunction with FIG. 1 is merely an example, rather than specifically limiting the method 300.

In block 302, the manager 101 receives a request for storing a data block from the virtual disk 105 of the virtual machine 102 into the virtual storage 104 of the virtual machine 102. The request includes indicating a virtual storage address for storing the data block in the virtual machine storage 104 and a virtual disk address for storing the data block in the virtual disk 105. When reading data in the virtual disk 105, the virtual machine 102 stores the data in the virtual disk 105 into the virtual storage 104. Thus, the virtual machine 102 sends a request to the manager 101. The request includes a storage address of the data block in the virtual disk 105 and a storage address to be used for storing the data block in the virtual storage 104.

In block 304, the manager 101 determines a physical storage address for storing the data block within a physical storage 103 associated with the virtual machine 102 based on the virtual disk address.

In some embodiments, the manager 101 determines whether the physical storage address for storing the data block is within the physical storage associated with the virtual machine based on the virtual disk address. The manager 101 allocates a new physical storage block from the physical storage 103, if no physical storage address for storing the data block is within the physical storage associated with the virtual machine. Then, the manager 101 reads the data block from a physical disk associated with the virtual disk 105 into the allocated new physical storage block. The manager 101 determines an address of the allocated new physical storage block for use as the physical storage address.

In block 306, the manager 101 associatively stores the virtual storage address and the physical storage address. After completing the storage, the virtual machine 102 may find out the corresponding data block based on the virtual storage address. Thus, the data block is stored into the virtual storage 104.

In the process of storing data in the virtual disk into the virtual storage, only by modifying a mapping relationship between the address of the physical storage and the address of the virtual storage of the data block, an operation of storing the data block from the virtual disk into the virtual storage is achieved, thus reducing the workload of copying the data block, and improving the data movement efficiency.

In addition, when storing the data block in the virtual disk 105 into the virtual storage 104, the manager 101 further determines a prior physical storage block that is in the physical storage 103 and corresponds to the storage block in the virtual storage based on the virtual storage address. After determining the prior physical storage block, the manager 101 releases the prior physical storage block. In some embodiments, the manager 101 finds a physical storage block corresponding to the virtual storage address based on the mapping table between the virtual storage 104 and the physical storage 103, and then releases a storage space occupied by the physical storage block. The above examples are merely used for describing some embodiments of the present disclosure, rather than specifically limiting the present disclosure.

After completing performing the above operations, the manager 101 sends a response to the virtual machine 102 to indicate the data block being stored into the virtual storage 104.

By determining a physical storage block that is in the physical storage and corresponds to a storage block of the virtual storage, and releasing a storage space corresponding to the physical storage, the storage space of the physical storage may be used for other data, thus improving the use efficiency of the physical storage.

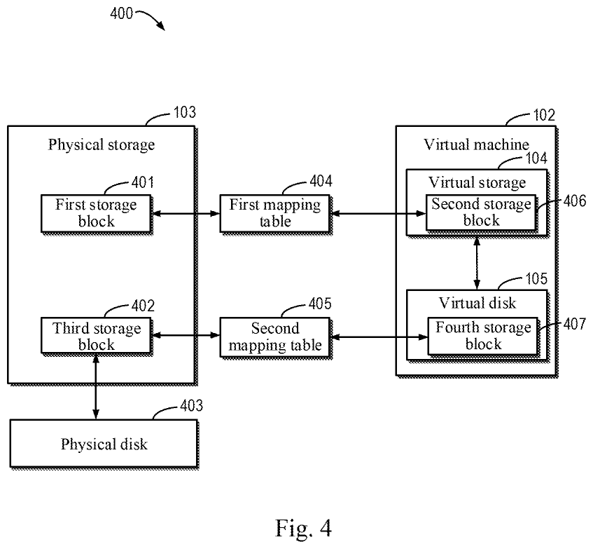

FIG. 4 shows a schematic diagram of an example environment 400 of starting a virtual machine according to an embodiment of the present disclosure. The example environment 400 includes the physical storage 103, the virtual machine 102, and a physical disk 403. The virtual machine 102 includes the virtual storage 104 and the virtual disk 105. The physical storage 103 is used for storing a data block in the virtual storage 104. Thus, a first mapping table 404 stores a mapping relationship between an address of a physical block for storing a data block in the physical storage 103 or an address of the data block in the physical storage 103, and an address of a storage block of a data block for storing data in the virtual storage 104 or the address of the data block in the physical storage 104. For example, the first mapping table 404 may be a shadow page table or an extended page table. A mapping relationship between a first storage block 401 and a second storage block 406 is stored in the first mapping table 404.

There is a second mapping table 405 between the virtual disk 105 and the physical storage 103. The second mapping table 405 stores a mapping relationship between an address of a storage block of a data block in the virtual disk 105 or the address of the data block in the physical storage 105, and an address of a storage block of the data block in the physical storage 103 or the address of the data block in the physical storage 103. A mapping relationship between an address of a fourth storage block 407 in the virtual disk 105 and an address of a third storage block 402 in the physical storage 103 is stored in the second mapping table 405. In an example, the second mapping table 405 may be a host page table. In addition, if no mapping relationship corresponds to the address of the data block in the virtual disk 105 or the address of the storage block of the data block in the second mapping table 405, then the data block in the virtual disk 105 is on the physical disk 403. Additionally, there is a file for reflecting a corresponding relationship of the data block or the storage block between the virtual disk 105 and the physical disk 403. In an example, the file is a host file.

In some embodiments, when storing a data block in the second storage block 406 of the virtual storage 104 into the fourth storage block 407 of the virtual disk 105, the manager 101 receives an address of the second storage block 406 and an address of the fourth storage block 407. The manager 101 finds out an address of the first storage block 401 in the first mapping table 404 based on the address in the second storage block 406. Then, the manager 101 searches for a mapping relationship of the fourth storage block 407 in the second mapping table 405, and if no mapping relationship of the fourth storage block is found, then stores the address of the first storage block 401 and the address of the fourth storage block 407 in the second mapping table 405. Thus, the data block may be found based on the address in the virtual disk 105, showing that the block is stored on the virtual disk 105. If a mapping relationship is related to the address of the fourth storage block 407 in the second mapping table 405, then the mapping relationship is modified to a mapping relationship between the address of the first storage block 401 and the address of the fourth storage block 407. In addition, the manager 101 releases a storage space occupied by the third storage block 402 corresponding to the fourth storage block 407.

In addition, because the first storage block 401 corresponds to the address in the virtual disk 105, it is necessary to further allocate a corresponding storage block for the second storage block 406 in the physical storage 103, and store the mapping relationship therebetween in the first mapping table 404. After completing performing the above operations, the manager 101 sends a response of completing a data transfer-out operation to the virtual machine 102.

In some embodiments, when storing a data block in the fourth storage block 407 of the virtual disk 105 into the second storage block 406 of the virtual storage 104, the manager 101 receives the address of the fourth storage block 407 and the address of the second storage block 406. The manager 101 performs a search in the second mapping table 405 based on the address of the fourth storage block 407 to find out whether there is a corresponding mapping relationship. If there is the corresponding mapping relationship, then the third storage block 402 corresponding to the fourth storage block 407 is in the physical storage 103. If there is no corresponding mapping relationship in the second mapping table 405, then data in the fourth storage block 407 are stored in the physical disk 403. Then, the manager 101 finds a data block corresponding to the fourth storage block 407 in the physical disk 403 based on a mapping relationship between the virtual disk 105 and the physical disk 403, then allocates the third storage block 402 in the physical storage 103, and reads the data block into the third storage block 402. Then, the manager 101 stores a mapping relationship between the address of the third storage block 402 and the address of the second storage block 406 in the first mapping table 404. Thus, the virtual machine 102 may find the data block based on the address in the virtual storage 104, showing that the data block is stored into the virtual storage 104.

In addition, it is further necessary to release the first storage block 401 corresponding to the second storage block 406. After completing performing the above operations, the manager sends a response of completing the data being stored into the virtual storage 104 to the virtual machine 102.

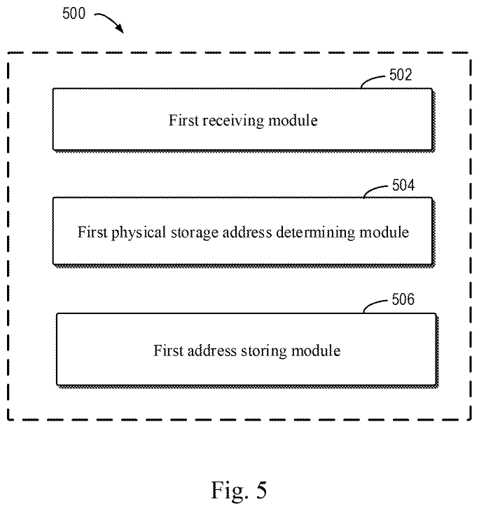

FIG. 5 shows a schematic block diagram of an apparatus 500 for processing data according to an embodiment of the present disclosure. The apparatus 500 may be included in the manager 101 of FIG. 1 or be implemented as the manager 101. As shown in the FIG. 5, the apparatus 500 includes a first receiving module 502 configured to receive a request for storing a data block from a virtual storage of a virtual machine into a virtual disk of the virtual machine, the request indicating a virtual storage address for storing the data block in the virtual storage and a virtual disk address for storing the data block in the virtual disk. The apparatus 500 further includes a first physical storage address determining module 504 configured to determine a physical storage address for storing the data block within a physical storage associated with the virtual machine based on the virtual storage address. The apparatus 500 further includes a first address storing module 506 configured to associatively store the virtual disk address and the physical storage address.

In some embodiments, the apparatus 500 further includes a first physical storage block determining module configured to determine whether a first physical storage block corresponding to a virtual disk storage block for storing the data block in the virtual disk is included in the physical storage based on the virtual disk address; and a first releasing module configured to release the first physical storage block, in response to the first physical storage block corresponding to the virtual disk storage block for storing the data block in the virtual disk is included in the physical storage.

In some embodiments, the apparatus 500 further includes a first allocating module configured to allocate a second physical storage block for the virtual machine storage in the physical storage; and a virtual storage address storing module configured to associatively store an address of the allocated second physical storage block and the virtual storage address.

In some embodiments, the apparatus 500 further includes a first sending module configured to send a response for the request to the virtual machine, to indicate the data block being stored into the virtual disk.

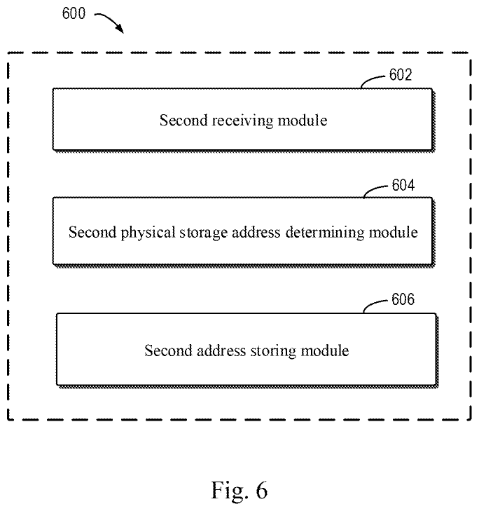

FIG. 6 shows a schematic block diagram of an apparatus 600 for processing data according to an embodiment of the present disclosure. The apparatus 600 may be included in the manager 101 of FIG. 1 or be implemented as the manager 101. As shown in the FIG. 6, the apparatus 600 includes a second receiving module 602 configured to receive a request for storing a data block from a virtual disk of a virtual machine into a virtual storage of the virtual machine, the request indicating a virtual storage address for storing the data block in a virtual machine storage and a virtual disk address for storing the data block in the virtual disk. The apparatus 600 further includes a second physical storage address determining module 604 configured to determine a physical storage address for storing the data block within a physical storage associated with the virtual machine based on the virtual disk address. The apparatus 600 further includes a second address storing module 606 configured to associatively store the virtual storage address and the physical storage address.

In some embodiments, the second physical storage address determining module 604 includes: a determining module configured to determine whether the physical storage address for storing the data block is within the physical storage associated with the virtual machine based on the virtual disk address; a second allocating module configured to allocate a first physical storage block from the physical storage, in response to no physical storage address for storing the data block within the physical storage associated with the virtual machine; a data block storing module configured to store the data block from a physical disk associated with the virtual disk into the first physical storage block; and a third physical storage address determining module configured to determine an address of the first physical block for use as the physical storage address.

In some embodiments, the apparatus 600 further includes a second physical storage block determining module configured to determine a second physical storage block that is in the physical storage and corresponds to a storage block of the virtual storage for storing the data block in the virtual storage based on the virtual storage address; and a second releasing module configured to release the second physical storage block.

In some embodiments, the apparatus 600 further includes a second sending module configured to send a response for the request to the virtual machine, to indicate the data block being stored into the virtual storage.

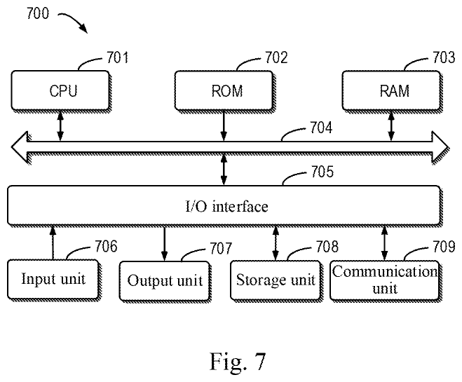

FIG. 7 shows a schematic block diagram of an electronic device 700 that may be configured to implement some embodiments of the present disclosure. The device 700 may be configured to implement the manager 101 of FIG. 1. As shown in the figure, the device 700 includes a computing unit 701, which may execute various appropriate actions and processes in accordance with computer program instructions stored in a read-only memory (ROM) 702 or computer program instructions loaded into a random access memory (RAM) 703 from a storage unit 708. The RAM 703 may further store various programs and data required by operations of the device 700. The computing unit 701, the ROM 702, and the RAM 703 are connected to each other through a bus 704. An input/output (I/O) interface 705 is also connected to the bus 704.

A plurality of components in the device 700 is connected to the I/O interface 705, including: an input unit 706, such as a keyboard, and a mouse; an output unit 707, such as various types of displays and speakers; a storage unit 708, such as a magnetic disk, and an optical disk; and a communication unit 709, such as a network card, a modem, and a wireless communication transceiver. The communication unit 709 allows the device 700 to exchange information/data with other devices via a computer network, e.g., the Internet, and/or various telecommunication networks.

The computing unit 701 may be various general purpose and/or special purpose processing components having a processing power and a computing power. Some examples of the computing unit 701 include, but are not limited to, a central processing unit (CPU), a graphics processing unit (GPU), various special purpose artificial intelligence (AI) computing chips, various computing units running a machine learning model algorithm, a digital signal processor (DSP), and any appropriate processor, controller, micro-controller, and the like. The computing unit 701 executes various methods and processes described above, such as the method 200 and the method 300. For example, in some embodiments, the method 200 and the method 300 may be implemented in a computer software program that is tangibly included in a machine readable medium, such as the storage unit 708. In some embodiments, a part or all of the computer program may be loaded and/or installed onto the device 700 via the ROM 702 and/or the communication unit 709. When the computer program is loaded into the RAM 703 and executed by the computing unit 701, one or more steps of the method 200 and the method 300 described above may be executed. Alternatively, in other embodiments, the computing unit 701 may be configured to execute the method 700 by any other appropriate approach (e.g., by means of firmware).

The functions described herein above may be performed, at least in part, by one or more hardware logic components. For example, and without limitation, exemplary types of hardware logic components that may be used include: Field Programmable Gate Array (FPGA), Application Specific Integrated Circuit (ASIC), Application Specific Standard Product (ASSP), System on Chip (SOC), Complex Programmable Logic Device (CPLD), and the like.

Program codes for implementing the method of the present disclosure may be written in any combination of one or more programming languages. These program codes may be provided to a processor or controller of a general purpose computer, special purpose computer or other programmable data processing apparatus such that the program codes, when executed by the processor or controller, enables the functions/operations specified in the flowcharts and/or block diagrams being implemented. The program codes may execute entirely on the machine, partly on the machine, as a stand-alone software package partly on the machine and partly on the remote machine, or entirely on the remote machine or server.

In the context of the present disclosure, the machine readable medium may be a tangible medium that may contain or store programs for use by or in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage medium may include an electrical connection based on one or more wires, portable computer disk, hard disk, random access memory (RAM), read only memory (ROM), erasable programmable read only memory (EPROM or flash memory), optical fiber, portable compact disk read only memory (CD-ROM), optical storage device, magnetic storage device, or any suitable combination of the foregoing.

In addition, although various operations are described in a specific order, this should not be understood that such operations are required to be performed in the specific order shown or in sequential order, or all illustrated operations should be performed to achieve the desired result. Multitasking and parallel processing may be advantageous in certain circumstances. Likewise, although several specific implementation details are included in the above discussion, these should not be construed as limiting the scope of the present disclosure. Certain features described in the context of separate embodiments may also be implemented in combination in a single implementation. Conversely, various features described in the context of a single implementation may also be implemented in a plurality of implementations, either individually or in any suitable sub-combination.

Although the embodiments of the present disclosure are described in language specific to structural features and/or method logic actions, it should be understood that the subject matter defined in the appended claims is not limited to the specific features or actions described above. Instead, the specific features and actions described above are merely exemplary forms of implementing the claims.

What is claimed is:

1. A method for processing data, comprising:
receiving a request for storing a data block from a virtual storage of a virtual machine into a virtual disk of the virtual machine, the request indicating a virtual storage address for storing the data block in the virtual storage and a virtual disk address for storing the data block in the virtual disk;
determining a physical storage address for storing the data block within a physical storage associated with the virtual machine based on the virtual storage address; and
associatively storing the virtual disk address and the physical storage address.

2. The method according to claim 1, wherein the method further comprises:
determining, based on the virtual disk address, whether a first physical storage block corresponding to a virtual disk storage block for storing the data block in the virtual disk is included in the physical storage; and
releasing the first physical storage block, in response to the first physical storage block being included in the physical storage.

3. The method according to claim 1, wherein the method further comprises:
allocating a second physical storage block for the virtual machine storage in the physical storage; and
associatively storing an address of the allocated second physical storage block and the virtual storage address.

4. The method according to claim 1, wherein the method further comprises:
sending a response for the request to the virtual machine, to indicate the data block being stored into the virtual disk.

5. A method for processing data, comprising:
receiving a request for storing a data block from a virtual disk of a virtual machine into a virtual storage of the virtual machine, the request indicating a virtual storage address for storing the data block in a virtual machine storage and a virtual disk address for storing the data block in the virtual disk;
determining a physical storage address for storing the data block within a physical storage associated with the virtual machine based on the virtual disk address; and
associatively storing the virtual storage address and the physical storage address.

6. The method according to claim 5, wherein the determining a physical storage address for storing the data block within a physical storage associated with the virtual machine comprises:
determining whether the physical storage address for storing the data block is within the physical storage associated with the virtual machine based on the virtual disk address;
allocating a first physical storage block from the physical storage, in response to no physical storage address for storing the data block within the physical storage associated with the virtual machine;
storing the data block from a physical disk associated with the virtual disk into the first physical storage block; and
determining an address of the first physical block for use as the physical storage address.

7. The method according to claim 5, wherein the method further comprises:
determining a second physical storage block that is in the physical storage and corresponds to a storage block of the virtual storage for storing the data block in the virtual storage based on the virtual storage address; and
releasing the second physical storage block.

8. The method according to claim 5, wherein the method further comprises:
sending a response for the request to the virtual machine, to indicate the data block being stored into the virtual storage.

9. An apparatus for processing data, comprising:
at least one processor; and
a memory storing instructions, wherein the instructions when executed by the at least one processor, cause the at least one processor to perform operations, the operations comprising:
receiving a request for storing a data block from a virtual storage of a virtual machine into a virtual disk of the virtual machine, the request indicating a virtual storage address for storing the data block in the virtual storage and a virtual disk address for storing the data block in the virtual disk;
determining a physical storage address for storing the data block within a physical storage associated with the virtual machine based on the virtual storage address; and
associatively storing the virtual disk address and the physical storage address.

10. The apparatus according to claim 9, wherein the operations further comprise:
determining based on the virtual disk address whether a first physical storage block corresponding to a virtual disk storage block for storing the data block in the virtual disk is included in the physical storage; and
releasing the first physical storage block, in response to the first physical storage block being included in the physical storage.

11. The apparatus according to claim 9, wherein the operations further comprise:
allocating a second physical storage block for the virtual machine storage in the physical storage; and
associatively storing an address of the allocated second physical storage block and the virtual storage address.

12. The apparatus according to claim 9, wherein the operations further comprise:
sending a response for the request to the virtual machine, to indicate the data block being stored into the virtual disk.

13. An apparatus for processing data, comprising: at least one processor; and a memory storing instructions, wherein the instructions when executed by the at least one processor, cause the at least one processor to perform operations, the operations including the method according to claim 1.

14. The apparatus according to claim 13, wherein the determining a physical storage address for storing the data block within a physical storage associated with the virtual machine comprises:
determining whether the physical storage address for storing the data block is within the physical storage associated with the virtual machine based on the virtual disk address;
allocating a first physical storage block from the physical storage, in response to no physical storage address for storing the data block within the physical storage associated with the virtual machine;
storing the data block from a physical disk associated with the virtual disk into the first physical storage block; and
determining an address of the first physical block for use as the physical storage address.

15. The apparatus according to claim 13, wherein the operations further comprise:
determining a second physical storage block that is in the physical storage and corresponds to a storage block of the virtual storage for storing the data block in the virtual storage based on the virtual storage address; and
a second releasing module configured to release the second physical storage block.

16. The apparatus according to claim 13, wherein the operations further comprise:
sending a response for the request to the virtual machine, to indicate the data block being stored into the virtual storage.

17. A non-transitory computer readable storage medium, storing a computer program thereon, wherein the program, when executed by a processor, implements the method according to claim 1.

18. A non-transitory computer readable storage medium, storing a computer program thereon, wherein the program, when executed by a processor, implements the method according to claim 5.
